(19) United States
(12) Patent Application Publication
(10) Pub. No.: US 2019/0164165 A1
(43) Pub. Date: May 30, 2019

(54) CROSS-DEVICE, MULTI-FACTOR AUTHENTICATION FOR INTERACTIVE KIOSKS

(71) Applicant: CA, Inc., Islandia, NY (US)

(72) Inventor: Ashok Kumar Ithabathula, Hyderabad (IN)

(21) Appl. No.: 15/824,394

(22) Filed: Nov. 28, 2017

(51) Int. Cl. G06Q 20/40; G06Q 20/18; G06Q 20/10; G06Q 20/32; H04L 29/06

(52) U.S. Cl. CPC G06Q 20/40145; G06Q 20/18; H04L 63/0861; G06Q 20/3278; G06Q 20/1085

(57) ABSTRACT

Provided is a process that includes: obtaining, from an interactive kiosk, with a remote authentication application, an account identifier; accessing a record that associates the account identifier with a mobile computing device; receiving, from the mobile computing device, a value indicative of whether a sensed biometric attribute matches a previously obtained biometric attribute; determining, based on the value, to authenticate the presenting user; and upon determining to authenticate the user, causing the interactive kiosk to provide access to a secured resource.

### BACKGROUND

### 1. Field

The present disclosure relates generally to cybersecurity and, more specifically, to cross-device, multi-factor authentication for interactive kiosks.

### 2. Description of the Related Art

Interactive kiosks have a variety of use cases. Often these computer-based systems dispense physical items from a secure repository. Examples include automatic teller machines that dispense currency or vending machines that dispense food items, electronics, gasoline, personal care items, and the like. In many cases, these interactive kiosks store the physical items in a secure repository and selectively release those items to users upon the users satisfying some condition precedent before the item can be accessed, e.g., paying for the item, or supplying credentials by which payment is effectuated. Further, such interactive kiosks in some cases dispense information, for example, about a user's account in some remotely hosted computer system, in some cases with or without dispensing physical items.

In many cases, it can be difficult to secure interactive kiosks. Often, the interactive kiosk is disposed in a public place, thereby providing physical access to malicious actors. Examples of attacks include card skimmers on ATM machines or vending machines that accept credit cards. Card skimmers are often paired with cameras or touch-sensitive covers for touchpads by which pin codes are captured. In these attacks, the card skimmer reads the account information from a user's card inserted into the interactive kiosk, and the cameras or covers for touchpads read the pin code entered by the user in association with the card. As a result, pin codes and other lower-security proxies, like ZIP Codes of users entered in association with transactions, often provide relatively little additional security benefits (none of which is to suggest that use of pin codes is disclaimed or the any other subject matter is disclaimed elsewhere herein).

### SUMMARY

The following is a non-exhaustive listing of some aspects of the present techniques. These and other aspects are described in the following disclosure.

Some aspects include a process including: obtaining, from an interactive kiosk, with one or more processors executing at least part of a remote authentication application, an account identifier, wherein: the remote authentication application is physically remote from the interactive kiosk, the account identifier distinguishes a given account from a plurality of accounts accessible via the interactive kiosk, the account identifier is communicated to the interactive kiosk from a physical token, the physical token is presented by a presenting user to the interactive kiosk, the presenting user is physically present at the interactive kiosk, and the account identifier is obtained based on data read from memory of the physical token upon presentation of the physical token to the interactive kiosk; accessing, with one or more processors executing at least part of the authentication application, a record that associates the account identifier with an identifier of a mobile computing device; receiving, with one or more processors executing at least part of the authentication application, from the mobile computing device associated with the account identifier obtained from the physical token by the interactive kiosk, via the network, a value indicative of whether a sensed biometric attribute matches a previously obtained biometric attribute of a biometric-verification user, wherein the value is obtained at least in part by sensing, with the mobile computing device, the biometric attribute of the biometric-verification user; determining, with one or more processors executing at least part of the remote authentication application, based on the value indicative of whether the sensed biometric attribute matches the previously obtained biometric attribute of the biometric-verification user, to authenticate the presenting user; and upon determining to authenticate the user, causing, with one or more processors executing at least part of the remote authentication application, the interactive kiosk to provide the presenting user access to a secured resource.

Some aspects include a tangible, non-transitory, machine-readable medium storing instructions that when executed by a data processing apparatus cause the data processing apparatus to perform operations including the above-mentioned process.

Some aspects include a system, including: one or more processors; and memory storing instructions that when executed by the processors cause the processors to effectuate operations of the above-mentioned process.

### BRIEF DESCRIPTION OF THE DRAWINGS

The above-mentioned aspects and other aspects of the present techniques will be better understood when the present application is read in view of the following figures in which like numbers indicate similar or identical elements:

FIG. 1 is a block diagram of a logical and physical architecture of a distributed computing environment in accordance with some embodiments of the present techniques;

FIG. 2 is a flowchart of a process that may be implemented in the computing environment of FIG. 1 in accordance with some embodiments of the present techniques;

FIG. 3 is a flowchart of a process that may be implemented in the computing environment of FIG. 1 in accordance with some embodiments of the present techniques; and

FIG. 4 is a block diagram of an example of a computing device by which the above techniques may be implemented.

While the present techniques are susceptible to various modifications and alternative forms, specific embodiments thereof are shown by way of example in the drawings and will herein be described in detail. The drawings may not be to scale. It should be understood, however, that the drawings and detailed description thereto are not intended to limit the present techniques to the particular form disclosed, but to the contrary, the intention is to cover all modifications, equivalents, and alternatives falling within the spirit and scope of the present techniques as defined by the appended claims.

### DETAILED DESCRIPTION OF CERTAIN EMBODIMENTS

To mitigate the problems described herein, the inventors had to both invent solutions and, in some cases just as importantly, recognize problems overlooked (or not yet foreseen) by others in the field of cybersecurity. Indeed, the inventors wish to emphasize the difficulty of recognizing those problems that are nascent and will become much more apparent in the future should trends in industry continue as the inventors expect. Further, because multiple problems are addressed, it should be understood that some embodiments are problem-specific, and not all embodiments address every problem with traditional systems described herein or provide every benefit described herein. That said, improvements that solve various permutations of these problems are described below.

Some embodiments supplement security measures in interactive kiosks with additional factors provided by users' mobile computing devices. In some embodiments, an authentication application determines whether to authenticate a user to engage in a transaction with an interactive kiosk based on a biometric measurement captured with the user's mobile computing device. This is expected to provide an independent factor for authenticating the user that is less susceptible to the types of attacks described above by which malicious actors tamper with interactive kiosks. It is much less likely that a bad actor will compromise both the interactive kiosk and the user's mobile computing device.

In some embodiments, additional aspects of a transaction with an interactive kiosk may also be configured with the mobile computing device. Examples include configuring selections of items or amounts of currency to be dispensed. In some cases, a user may engage in a transaction with an interactive kiosk without touching a user interface of the interactive kiosk.

In some embodiments, access to a user's account via an interactive kiosk may be delegated to another user. For example, a user may give their friend their ATM card and, then, remotely authorize a transaction via biometric measurement taken with their mobile computing device. Thus, in some use cases, a user need not be physically present at an interactive kiosk to delegate access to another user via the interactive kiosk. In some embodiments, the remote user may be presented with an image or sequence of images in a video feed captured by the interactive kiosk, so that they can confirm that the user seeking access with their card or other physical token is in fact the person to whom they delegated access.

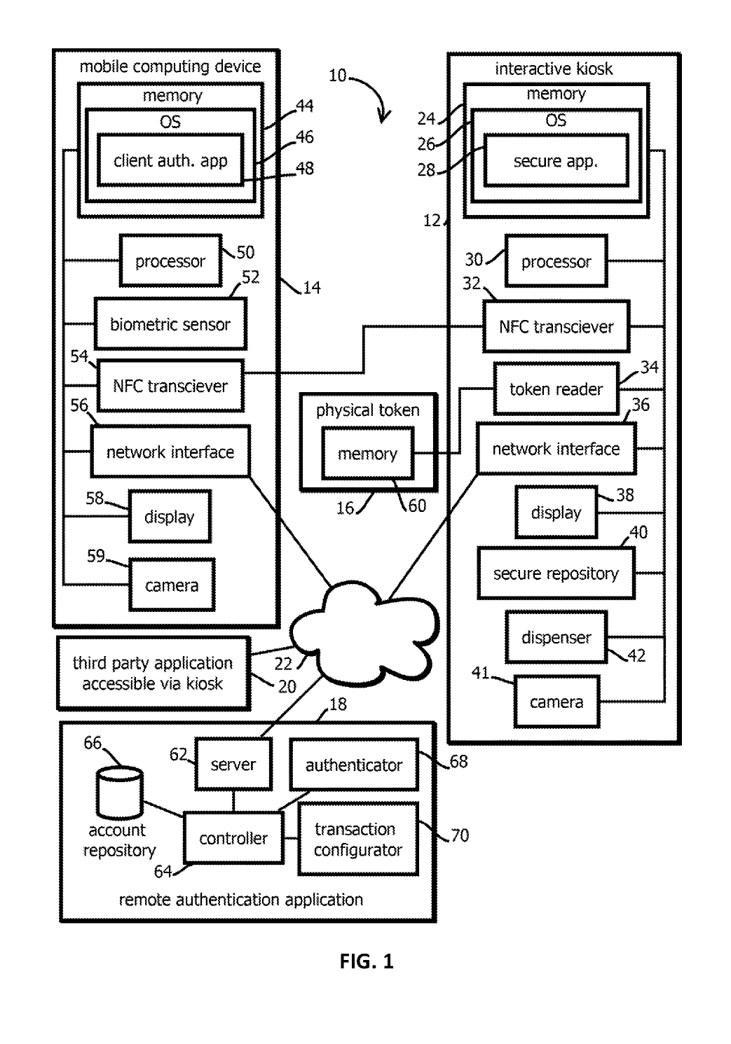

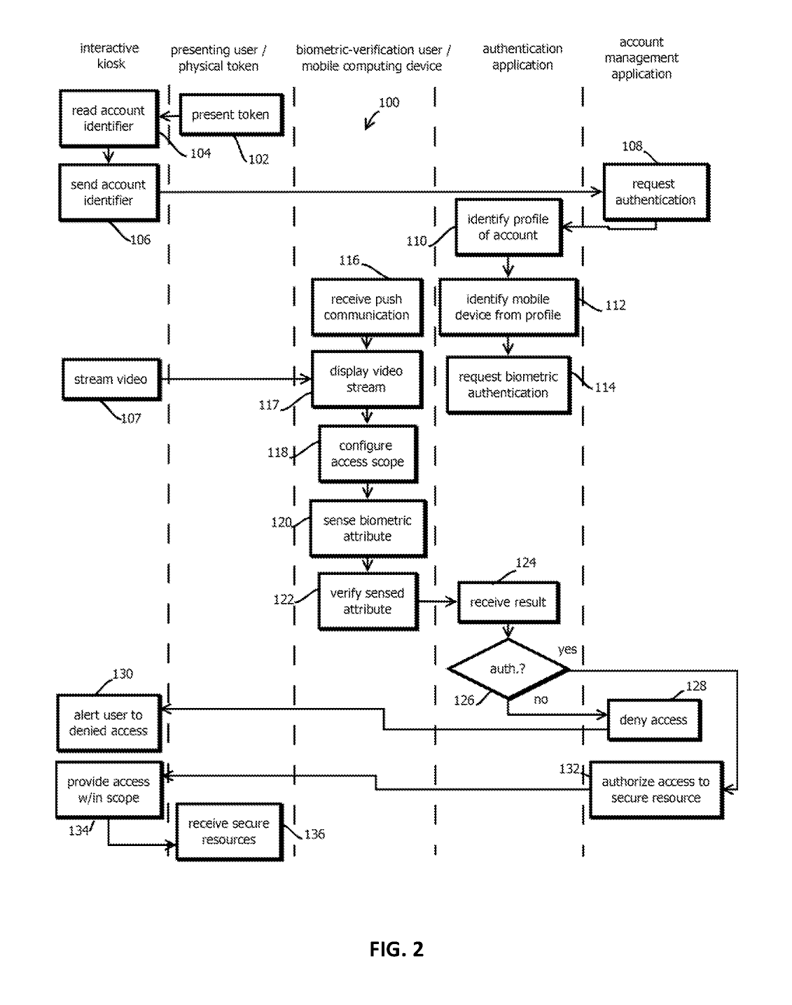

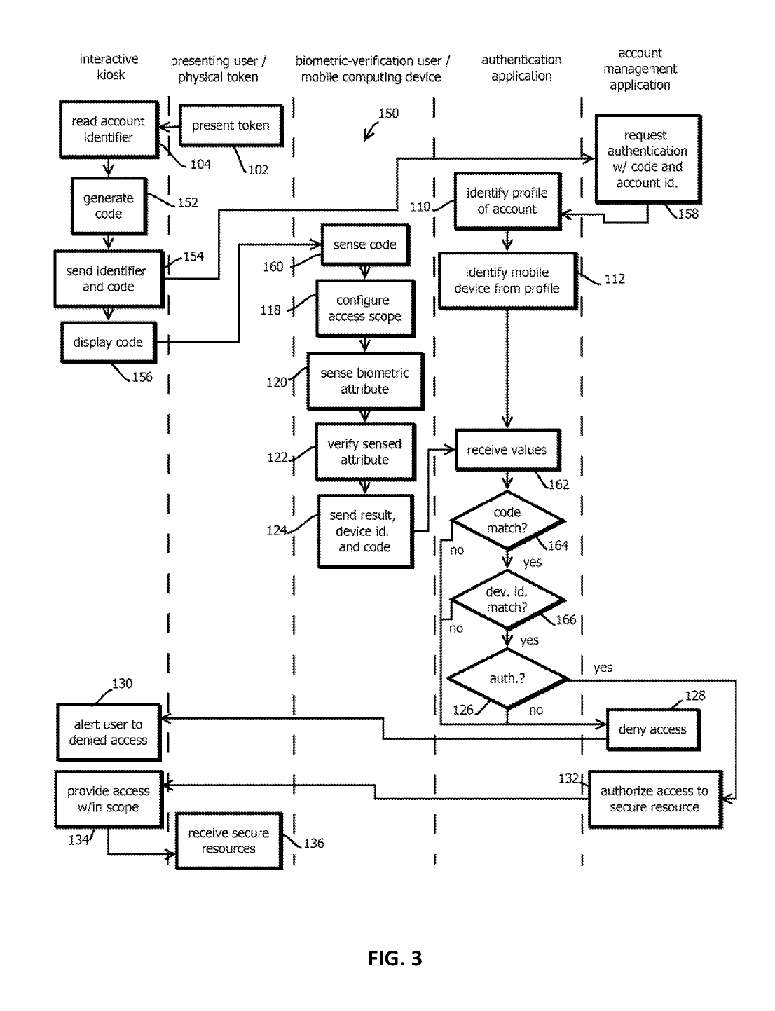

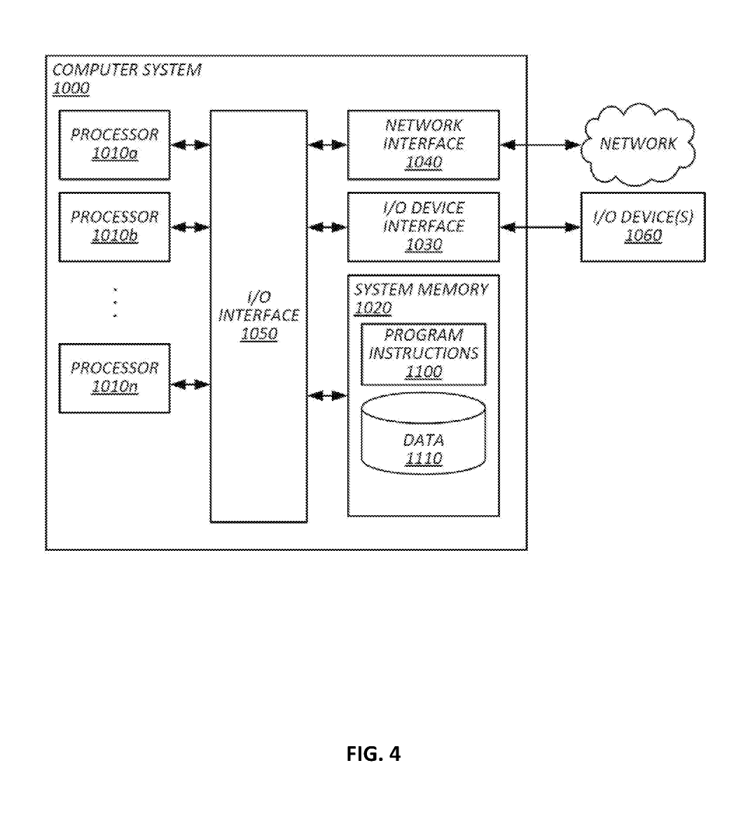

Various subsets of these, and in some cases all of these techniques, along with other techniques, may be implemented in a computing environment 10 described below with reference to FIG. 1. Various approaches may be used in this system to link a mobile computing device to an access request an interactive kiosk. In some embodiments, the computing environment may execute a process described below with reference to FIG. 2 by which push notifications tie the user's mobile computing device to an access request initiated with that user's physical token, such as a ATM card or credit card. In some embodiments, the computing environment 10 may execute a process described below with reference to FIG. 3 by which the user's mobile computing device is tied to an access request via a wireless conveyance of a one-time code from the interactive kiosk to the mobile computing device. In some embodiments, these techniques may be implemented with computers like those described below with reference to FIG. 4.

In some embodiments, the computing environment 10 includes an interactive kiosk 12, a mobile computing device 14, a physical token 16, a remote authentication application 18, and a third-party application accessible via the kiosk 20. In some embodiments, these components may communicate with one another via a network 22, such as the Internet and various intermediary networks, like local area networks, wireless area networks, cellular networks, and the like.

In this example, the mobile computing device 14, the physical token 16, and the interactive kiosk 12 may be geographically collocated during examples of the transactions described below, for instance, within Bluetooth or near field communication (NFC) wireless transmission range of one another. In some cases, the physical token and mobile computing device 14 may be in physical contact with the user, while the user physically makes contact between the physical token 16 and the interactive kiosk 12 to transfer data from the physical token 16 to the interactive kiosk 12. Or in some use cases, the mobile computing device 14 may be remote from the interactive kiosk 12, for example when a user delegates access to a friend.

A single set of a mobile computing device 14, interactive kiosk 12, and physical token 16 are shown by way of example, but commercial implementations are expected to include substantially more instances of each. For example, implementations may include more than 1000, like more than 10,000, interactive kiosks geographically distributed over an area, for example, more than 1000 km², like a state or country, or continent. Similarly, there may be more than 100,000, for instance, more than 10 million, mobile computing devices 14 distributed over a similarly sized area.

In some embodiments, the interactive kiosk 12 is an interactive kiosk that dispenses physical goods, like paper (or plastic or metal) currency, food items, gasoline, diesel, electronics, personal care items, and the like. In some embodiments, the interactive kiosk 12 is a vending machine, a gas station pump, or an automated teller machine. In some embodiments, the interactive kiosk 12, either alternatively or additionally, provides a computer-implemented user interface (e.g., on a touchscreen) by which a user may access information in an account of the user, for example, an account stored remotely and accessible via the third-party application, which may be remotely accessible via the kiosk 20. In some embodiments, the interactive kiosk 12 is a terminal for a security system by which physical access is provided to some space via an actuator controlled by the interactive kiosk 12, such as a smart lock or an automated door, examples including a public locker for storing delivered packages accessible via a solenoid-controlled lock, or the like.

In some embodiments, the mobile computing device 14 is a smart phone, tablet computer, wearable computing device, in-dash automotive computer, or other computing device having a mobile source of power (such as a battery) and one or more wireless radios by which the mobile computing device 14 may access the network 22. Examples of such radios include cellular radios, Wi-Fi™ radios, Bluetooth™ radios, and the like. In some embodiments, the mobile computing device 14 is a handheld mobile computing device.

In some embodiments, the physical token 16 is carried by the user as a means of at least partially authenticating the user (e.g., to identify the user, or both identify and provide at least one factor for authentication). Thus, token 16 may, upon being read, identify the user to one or more instances of the interactive kiosk 12. Examples include ATM cards, credit cards, identification cards (like drivers licenses or passports), and the like, in some cases having a chip or magnetic strip thereon with memory 60 storing an account identifier or value from which an account identifier may be determined. In some embodiments, the physical token 60 is integrated with the mobile computing device 14 or a different mobile computing device. In some embodiments, the token may include (or be) an application on the mobile computing device that causes the mobile computing device to wirelessly transmit an account identifier, for example, via near field communication, to the interactive kiosk 12. In some embodiments, the physical token 16 is a USB key or near field communication card readable by the interactive kiosk 12.

In some embodiments, the remote authentication application 18 is configured to authenticate (or determine not to authenticate) users based upon a plurality of credentials presented by the users. These credentials may include presentation of the physical token 16, various passwords (like pin codes), physical possession of the mobile computing device 14, and demonstrating possession of biometric attributes sensed with the mobile computing device 14. In some embodiments, the remote authentication application 18 is formed from one or more computing entities, like computing devices, virtual machines, containers, unikernels, and the like hosted in a remote data center relative to the interactive kiosk 12. In some embodiments, the different components of the remote authentication application 18 may be replicated behind load balancers to provide relatively low-latency responses for relatively high transaction volumes. Or in some embodiments, a single computing device may implement the remote authentication application 18.

In some embodiments, the remote authentication application 18 may provide authentication services on behalf of a third-party application accessible via the kiosk 20, which may itself be formed with another collection of computing entities like those described above, for example in the same or a different data center. In some embodiments, the remote authentication application 18 may be integrated with the third-party application accessible via the kiosk 20. In some embodiments, each of these components 18 and 20 may be integrated with the interactive kiosk 12, for example, within a single physical enclosure.

In some embodiments, the third-party application is a banking application by which credit card accounts or bank accounts or other payment accounts are accessed via the interactive kiosk. Access may include effectively authorizing the transfer of funds into or out of such an account to or from some other entity, for instance, to effectuate a transaction on the interactive kiosk 12. Access may also include querying attributes of user profiles, such as list of accounts, balances, user identifiers, authorizations associated with those accounts, and in some cases changing these values.

In some embodiments, the interactive kiosk 12 includes an integrated computing device and a plurality of devices by which that computing device physically interacts with the environment of the interactive kiosk 12. In some embodiments, the interactive kiosk 12 includes memory 24 storing program code of an operating system 26 in which a secure application 28 executes. In some embodiments, the memory 24 is system memory of a computing device of the interactive kiosk 12 and stored as program code of the secure application 28. In some embodiments, the secure application 28 may be an application that determines whether to provide access to a user responsive to signals from the third-party application 20, the remote authentication application 18, or both. In some cases, the secure application 28 may execute the operations described below in FIGS. 2 and 3 as being attributed to the interactive kiosk 12.

In some embodiments, the interactive kiosk 12 may further include a processor 30, such as a central processing unit, a near field communication transceiver 32 (or other wireless radio having an antenna, like a Bluetooth™, Zigbee™, or Wi-Fi™ transceiver), a token reader 34, a network interface 36, a display 38, a secure repository 40, a camera 41, and a dispenser 42 (or other actuator).

In some embodiments, the processor 30 may be coupled to the memory 24 on a motherboard or other system board of the interactive kiosk 12, along with the other illustrated components. In some embodiments, the processor 30 may execute the instructions stored in the memory 24 to effectuate the functionality of the interactive kiosk 12 described herein.

In some embodiments, the near field communication transceiver 32, or other wireless transceiver, may directly wirelessly communicate with the mobile computing device 14 or the physical token 16, depending upon the use case, via wireless signals, such as wireless signals having a relatively short range thereby ensuring physical proximity. In some embodiments, the range of the transceiver 32 may be less than 200 meters (m), such as less than 100 m, and in some cases less than 1 m. In some embodiments, the NFC transceiver 32 may include an antenna by which signals are sent and received wirelessly. As described in greater detail below, in some embodiments, a one-time code may be wirelessly transmitted from the interactive kiosk 12 to the mobile computing device 14 to provide a value that associates the mobile computing device 14 with an ongoing transaction (for example, in non-delegated access requests). Or in some embodiments, this code may be transmitted wirelessly with other means, for example, by optical transmission. For example, some embodiments may display the code on the display 38, and a camera of the mobile computing device 14 may capture an image of the code, for example, as encoded in a barcode, QR code, sequence of flashes, or text suitable for optical character recognition. Or in some embodiments, as noted above, the physical token 16 may be implemented within the mobile computing device 14, and the account identifier conveyed by the physical token may be conveyed via an NFC transmission from the mobile computing device 14 to the interactive kiosk 12, or via optical transmission, by displaying a QR code, barcode, sequence of flashes, or other optical encoding on a display of the mobile computing device 14, which may be captured by a camera of the interactive kiosk 12.

In some embodiments, the interactive kiosk 12 includes a token reader 34, which in some cases may be integrated with the transceiver 32, depending upon the form taken by the token 16, which is not to suggest that any other set of features may not also be integrated into a single device or operation. In some embodiments, the token reader 34 includes a magnetic strip reader configured to read magnetic strips from a physical token 16, or in some embodiments, the token reader 34 includes a chip reader configured to make physical contact via resilient conductive pins with contacts on a chip mounted in the physical token 16 to read data from memory 60. In some embodiments, the token reader 34 includes a USB port by which a USB dongle is plugged into the interactive kiosk 12, when the physical token takes the form of a USB dongle.

In some embodiments, the interactive kiosk 12 includes a network interface to the network 22, such as a wired Ethernet network interface card, a cellular connection, a Wi-Fi™ connection, or the like.

In some embodiments, the interactive kiosk 12 includes a display 38, such as a LED or OLED display having a touch-sensitive surface, or arrays of buttons along the perimeter of the surface, by which a user's physical contact with the interactive kiosk 12 may be mapped to various user interface elements displayed on the display 38 by the secure application 28. Or in some embodiments the interactive kiosk may be a headless interactive kiosk without a display, which is not to suggest that any other described feature may not also be omitted in some embodiments.

In some embodiments, the interactive kiosk 12 further includes a secure repository 40, such as a chamber in which currency is contained, a repository for dispensed items, a tank connected to the dispenser 42 via a pump controlled by the secure application 28, a region of a building accessible via a door controlled by the interactive kiosk 12, or a locker to which access is selectively provided by the interactive kiosk 12. In some embodiments, the secure repository 40 may include one or more locks, which may be the same or distinct from the dispenser 42 by which physical access may be selectively granted to the secure repository 40, for example, to restock dispensed items. In some embodiments, the secure repository 40 may be fully surrounded by a barrier, such as a metal barrier, that prevents physical access to dispensed items absent authentication via the interactive kiosk 12 or a physical key.

In some embodiments, the dispenser 42 includes one or more actuators by which the interactive kiosk 12 selectively provides access to one or more resources in the secure repository 40. In some embodiments, the actuator 42 includes a, automated lock (such as a pin biased into a hole by a resilient member and driven out of the hole by a solenoid or other electromagnet, or an actuator for an automated door), a stepper motor configured to dispense currency via physical contact with a top unit of a stack of currency in the secure repository 40, or an array, such as a matrix, of actuators in a vending machine by which selected items are selectively dispensed.

In some embodiments, the interactive kiosk 12 further includes a camera, such as a video camera, by which images, such as video, of a user presenting the physical token 16 and seeking to gain access may be captured. In some embodiments, the interactive kiosk may send images, such as video of this user to a remote user, such as a remote user with the mobile computing device 14, so that a remote user delegating access can confirm that the person physically present at the interactive kiosk is the person to whom they delegated access. In some embodiments, the secure application 28 is further configured to establish a two-way video and audio communication link between the mobile computing device 14 and the interactive kiosk 12, such that the operator of the mobile computing device 14 may communicate with the delegated access user physically present at the interactive kiosk 12, for example, to request the user to engage in various activities by which the user is demonstrated to be a non-previously-recorded representation of the user.

In some embodiments, the mobile computing device 14 includes memory 44 storing program code for an operating system 46 and a client authentication application 48 that runs within the operating system 46. In some embodiments, the operations attributable to the biometric verification user's mobile computing device in the processes of FIGS. 2 and 3 may be executed by the client authentication application 48. In some embodiments, the mobile computing device 14 further includes a processor 50, a biometric sensor 52, a near field communication transceiver 54, a network interface 56, a display 58, and a camera 59.

In some embodiments, the processor 50 may communicate with the memory 44 and the other illustrated components of the member mobile computing device 14 via the system board. One processor 50 is shown, but some embodiments may include multiple processors. For example, some embodiments may include a discrete separate processor for accessing secure data, such as in a secure enclave. In some embodiments, parameters of models, or models themselves, by which biometric measurements are classified as corresponding to a previously configured user account may be stored in secure memory (e.g., memory having an address space accessible only via the separate processor different from a CPU that executes the OS and the authentication application), in some cases without such data leaving secure memory or the secure processor. In some embodiments, the secure processor may communicate with the central processing unit via interrupts, with relatively limited exchanges of data therebetween, and with different memory addresses spaces, and in some cases different physical memory, assign thereto, thereby impeding or preventing approaches like buffer overflow attacks by which secure memory may be accessed.

Some embodiments may include a biometric sensor 52. Some embodiments may include a plurality of biometric sensors configured to sense different biometric attributes. In some embodiments, the biometric sensor includes a fingerprint scanner, an iris scanner, a retina scanner, or a facial recognition scanner. In some embodiments, the biometric sensor 52 may be implemented with an array or matrix of capacitive sensors, for example, configured to sense the structure of a fingerprint. In some embodiments, the biometric sensor 52 may be implemented with a depth-sensing camera, a thermal-imaging camera, and an optical camera, which in some cases may be integrated. In some embodiments, the biometric sensor 52 may be configured to transmit a pattern onto a person's body being measured, such as a pattern sensed with a camera to discern depth. In some embodiments, depth, optical, and thermal measurements may be combined and input into a facial recognition model, for instance, executing within a secure processor, that is trained on previous inputs to classify the data as indicating the presence of a specific user or not, e.g., with a false positive rate of less than 1 in 1000, like less than 1 in 10,000.

In some embodiments, the processor 50 or other secure processor of the mobile computing device 14 may be configured to receive measurements from the biometric sensor 52 and classify those measurements, for example, scoring those measurements and comparing that score to a threshold, according to whether the measurements correspond to previous measurements of a known user. For example, a user may configure the mobile computing device 14 to recognize their biometric attributes by supplying a plurality of measurements to the biometric sensor 52, for example, in advance of an interaction with the interactive kiosk 12. In some embodiments, the user may supply 5, 10, 20, or more such measurements in advance, and some embodiments may train or otherwise calibrate a classification model on those measurements. For example, some embodiments may adjust the parameters of the model, for example iteratively, with a stochastic gradient descent, to minimize an amount of miss classifications relative to the training set. In some embodiments, classification of biometric measurements as corresponding to a user may be done on-board on the mobile computing device 14, without biometric attribute measurements being sent to a remote computing device, thereby enhancing the user's privacy, and reducing the risk of a user's biometric measurements being permanently rendered less useful in virtue of a data breach of a central repository. Or some embodiments may consolidate these values, for example, upon encrypting these values and sending them to a remote database. Some embodiments may calculate a cryptographic hash based upon biometric attributes, both during training and during classification, and the cryptographic hashes may be compared at a remote server to determine whether a biometric attribute is a valid match for a given user (e.g., if the hash values match). In some embodiments, those biometric attributes may be binned, for example, converted to a lower resolution, for instance, by dropping less significant digits or otherwise clustering biometric measurements, to reduce the impact of noise on such cryptographic hashes.

In some embodiments, the mobile computing device 14 further includes a near field communication transceiver 54 or other wireless transceiver configured for use cases in which values are communicated with the NFC transceiver 32 of the interactive kiosk 12. Again, this NFC transceiver may include an antenna by which signals are sent and received.

In some embodiments, the mobile computing device 14 further includes a network interface 54, which in some cases may include a baseband processor (e.g., distinct processor from a CPU) and cellular network interface. Some embodiments may further include a network interface for other wireless networks, such as a Wi-Fi™ network, a Bluetooth™ network, or the like.

In some embodiments, the mobile computing device 58 may further include a display, such as a touch screen display having multitouch capabilities, and in some cases, a force sensitive multitouch display. In some embodiments, a user may interact with a user interface of the client authentication application 48 by touching portions of the display mapped to user interface elements of the client authentication application. In some embodiments, the display 58 may display images, such as video, captured by the camera of the interactive kiosk 12 of a user attempting to present the physical token 16 in delegated access scenarios. Further, the display may include a user interface by which a user enters additional credentials, like a pin code, a password, or a swipe pattern. These additional credentials may be conveyed (e.g., in the form of a cryptographic hash based on the entered value and a salt value) and validated with the techniques described below, e.g., locally or at the remote authentication application by determining whether the cryptographic hash value matches a stored cryptographic hash value.

In some embodiments, the mobile computing device 14 further includes the camera 59, which in some cases may capture images of a user of the mobile computing device 14 that are sent to the interactive kiosk 12 for presentation on the display 38, for example in a video chat with a user to whom access has been delegated. Further, some embodiments of the client authentication application 48 may be configured to capture images of the display 38 on the kiosk 12 to wirelessly convey data between the interactive kiosk 12 and the mobile computing device 14, for example, in non-delegated access use cases in which the NFC transceivers 54 are not engaged to exchange a code value (and in use cases in which the below-described push notification is not implemented, instead or additionally). For example, some embodiments may be configured to capture an image of a QR code, a barcode, or other machine-readable image on the display 38 that encodes a one-time code associated with a given presentation of the physical token 16. In some embodiments, the client authentication application 48 may receive an image captured by the camera 59 of that machine-readable image and extract the one-time code from the image, for example, by detecting reference features and, responsive to spatial arrangements of the reference features, executing perspective affine transforms and scaling transforms to normalize the image before implementing edge detection algorithms and classifying positions of edges in transformed images as designating values in a sequence of values of a one-time code associated with presentation of the physical token 16.

In some embodiments, the interactive kiosk security application 28 may be configured to generate a new instance of the code with each presentation of the physical token 16. In some embodiments, the code may be relatively short to facilitate use cases in which a user manually types the code into a touch screen of the mobile computing device 14, e.g., less than or equal to 8 characters. In some embodiments, the code may be sufficiently long that it is difficult to guess with a brute force attack. To this end, in some embodiments, the code may have more than 8-bits of entropy, more than 12-bits of entropy, more than 16-bits of entropy, or more than 32-bits of entropy. In some embodiments, the code may be generated with a pseudo random number generator, for instance, with a linear shift register algorithm or call to a RDRAND operator. In some embodiments, a new instance of the code may be generated by the secure application 28 with each presentation of a physical token 16, such that a given user repeatedly presenting the physical token 16 in different transactions may have a different code generated for each transaction. In some embodiments, this code may be sent by the mobile computing device 14 to the remote authentication application 18, along with an identifier of the mobile computing device 14, and the remote authentication application 18 may match this code with an instance of the code received from the interactive kiosk 12 and an account identifier sent from the interactive kiosk 12 to match indications of biometric measurements from the mobile computing device 14 with transactions on the interactive kiosk 12, as described in greater detail below with reference to FIG. 3.

In some embodiments, the remote authentication application 18 may include a server 62, a controller 64, an authenticator 68, a transaction configurator 70, and an account repository 66. In some embodiments, the server 62 may be a nonblocking API server, such as a web server, configured to receive messages via an Internet Protocol address and port number assigned to the remote authentication application 18. In some embodiments, messages may be sent via the server 62 back onto the network 22 to messaged devices. In some embodiments, the controller 64 may communicate with other components of the computing environment 10 via the server 62. In some embodiments, the controller 64 may coordinate the operations of the other components of the remote authentication application 18 and effectuate the operations described below with reference to FIGS. 2 and 3 as being attributable to the authentication application.

In some embodiments, the authenticator 68 may be configured to determine whether to authenticate requests to access resources via the interactive kiosk 12. In some embodiments, the determination may be based upon records stored in the account repository 66. In some embodiments, the account repository 66 may include a plurality of accounts identifiable by account identifiers received from the interactive kiosk 12 (which in some cases may be different respective corresponding values that are transformed between being received from the physical token and used to identify an account, for example, in into the form of a cryptographic hash of an account value identifier read from memory 60. This arrangement is consistent with (and an example of) reference to a single account identifier herein, as the account repository 66 may include a plurality of accounts having user profiles identifiable by the user account identifiers. In some embodiments, the account identifiers may distinguish different records in the account repository from one another. In some embodiments, a given user may have a single account or multiple accounts. In some embodiments, accounts in different systems may be mapped to one another in a variety of arrangements: a single account within the account repository 66 may mapped to multiple accounts accessible via the third-party application; there may be a one-to-one correspondence; or multiple accounts accessible via the third-party application or other third-party applications may be mapped to a single account in the account repository 66.

In some embodiments, each account may include a record identifying an account identifier like those received from the interactive kiosk 12, a mobile computing device identifier (like a UDID, a MAC address, and ADID, a public cryptographic key (corresponding to a private key on the mobile device with which messages are cryptographically signed), or other identifier that distinguishes among mobile computing devices having records in the account repository 66), a password (like a pin code), and in some cases reference data for comparing biometric attributes to previously captured biometric attributes to classify a user as by biometrically authenticated (or as described above, some embodiments may exclusively store this data and perform these operations on the mobile computing device 14 to protect the biometric data).

In some embodiments, authenticator 68 may be configured to authenticate a user in a given access request based on a variety of criteria, and in some cases a combination of these criteria. In some embodiments, the authenticator 68 may authenticate an access request. The access request may be responsive to an account identifier obtained via the physical token 16, and the token may be read by the interactive kiosk 12. The identifier may be mapped to a record in the account repository 66 having an identifier of a mobile computing device 14. And the mobile computing device may be a designed device, among a plurality of such devices of other users, from which data indicating a biometric measurement of a biometric attribute corresponding to a designated user is obtained.

For example, some embodiments may receive an account identifier from the interactive kiosk 12 (upon a corresponding physical token 16 being presented). Some embodiments may then access a record in the account repository 16 corresponding to that account identifier. Some embodiments may then identify a mobile computing device within that record associated with the account identifier. Some embodiments may then push a biometric authentication request to that mobile computing device, for example, to a network address, like a phone number or Internet Protocol address) of that identified mobile computing device. In some embodiments, the client authentication application 48 may receive this push requests, and in response, display an alert on display 58 and inviting the user to supply their credentials via a user interface presented responsive to selection of an input in the notification and, in some cases, view images from the camera 43 of the interactive kiosk 12.

In some embodiments, the client authentication application 48 may further present a user interface by which a user may define the scope of access to be granted, for example, configuring a transaction with the interactive kiosk 12. In some embodiments, configuring the transaction may include specifying or otherwise selecting items to be dispensed, specifying an amount of items to be dispensed, specifying a scope of access, or supplying additional credentials. For instance, a user may input an amount of currency to be dispensed, specify a selection of denominations of currency, select a vending machine item, specify an amount of fuel to be dispensed, or the like.

In some embodiments, upon specifying or otherwise configuring the transaction, and in some cases viewing images of a user at the interactive kiosk 12, some embodiments may invite, via the client authentication application 48, the user to supply a biometric measurement via the biometric sensor 52. Examples include inviting the user to scan their fingerprint, their face, their iris, their retina, or the like. In some embodiments, the authenticator 68 may receive data based on these measurements, such as a result of the classification done on the mobile computing device 14, or a cryptographic hash value based upon down-resolution transformations of these measurements, by which the authenticator 68 may make an independent determination of whether biometric attributes match those associated with the user. In some embodiments, the authenticator 68 may advance the transaction configuration to the transaction configurator 70 and determine whether to authenticate the user, for example, based upon the designated mobile computing device 14 supplying data indicating that the person in possession with that mobile computing device is able to supply a measurement of a biometric attribute that matches previous measurements of a biometric attribute of a user.

In some embodiments, the transaction configurator 70 may be configured to specify the scope of access to effectuate the selections made on the client authentication application 48 by a user. In some embodiments, this may include transmitting the configuration to the third party application 20 or the interactive kiosk 12, which may enforce the limitations on scope, providing access to resources within the scope and preventing access to resources outside the scope. Or in some embodiments, configuration may be input partially or fully by the user at the interactive kiosk via a user interface of the interactive kiosk, which is not to suggest that any other described feature is not also amenable to variation. In some embodiments, the user of the mobile device may specify constraints within which a user at the interactive kiosk further configures a transaction. For instance, a user of the mobile device may specify that two items are to be dispensed, but leave the selection of which items to the user physically present at the interactive kiosk. In some cases, a determination of whether a transaction complies with the constrains may be made at the interactive kiosk or at the third-party application.

In some embodiments, indications of biometric measurements from the mobile computing device 14 may be matched to transaction requests on the interactive kiosk 12 with techniques other than push notifications to mobile computing devices associated with account identifiers received from the interactive kiosk 12. (Making such matches may be relatively difficult in cases in which there are hundreds or thousands of concurrent sessions per minute from hundreds or thousands of interactive kiosks requesting remote authentication.) For example, some embodiments may generate a one-time use code that expires after some threshold duration of time, like 15-minutes, 30-minutes, an hour, a day, a week, or more. In some embodiments, the one-time use code may be generated by the interactive kiosk 12. The code is referred to as one-time code in the sense that the code changes between transactions with the interactive kiosk, but portions of the namespace of the code may be reused, for example, after the threshold duration of time, or upon pseudorandom selection. In some embodiments, a relatively small portion of the namespace of the code may be in use at any one instance of the duration of time, making it relatively difficult for an attacker to guess which portions are in use. To further impede brute force attacks, some embodiments may determine authentication access request rates and rate limit such access requests.

In some embodiments, the one-time code may be wirelessly conveyed between the interactive kiosk 12 and the mobile computing device 14, for instance, in cases in which access is not delegated. In some embodiments, the mobile computing device 14 may then transmit that one-time code (also called a one-time use code) to the remote authentication application 18, and the authenticator 68 may match that transmitted code with a similar instance of the code received from the interactive kiosk 12 along with the account identifier. In some embodiments, the authenticator 68 may determine whether the mobile computing device identifier received with the code matches a mobile computing device identifier in a, account's user profile that matches the account identifier received from the interactive kiosk also associated with the same one-time code. Upon determining that they do not match, some embodiments may determine not to authenticate a transaction, or upon determining that they do match, some embodiments may authenticate the transaction, in some cases conditional upon a value from the mobile computing device 14 being received indicating that a biometric attribute of the user matches previously supplied biometric attributes of the user.

In some embodiments, a result of the authentication determination may be conveyed from the application 18 to the interactive kiosk 12 directly, and the interactive kiosk 12 may effectuate the result of the determination, for example, displaying a message indicating that the user is not authenticated, or providing access within the scope of defined access in the configuration provided by the mobile computing device 14, or generally providing access within the scope of access afforded a given user, for instance, when such configurations are not done on the mobile computing device 14. Or in some embodiments, the result of the determination, the configuration, or both may be conveyed directly from the remote authentication application 18 to the third-party application 20, which in some cases may interface between the interactive kiosk 12 and the application 18 for some or all of the exchanges therebetween to effectuate constrains and authentication determinations, thereby effectuating similar or the same resulting functionality via the third-party application 20.

FIG. 2 shows an example of a process 100 that may be implemented in the computing environment 10 described above, but is not limited to that implementation, which is not to suggest that any other description is limiting. In some embodiments, the operations of the process 100 may be effectuated by executing with one or more processors program code encoding instructions stored on a tangible, non-transitory, machine-readable medium. In some embodiments, different subsets of those instructions may be executed by different computing devices or media corresponding to the different column shown in FIG. 2 (and FIG. 3, and other described functionality). Such instructions may specify the described functionality of the following: the interactive kiosk, the physical token, mobile computing device, the authentication application, and an account management application, like the third-party application 20 described above. In some embodiments, the operations may be performed in a different order, additional instances of operations may be inserted, operations may be omitted, the operations may be performed serially in the order described, some of the operations may be performed concurrently, or some operations may be repeated, none of which is to suggest that any other description herein is limiting.

In some embodiments, the process 100 it begins with the presenting user (i.e., the user physically present at the interactive kiosk, which may be the same or different from the user supplying biometric credentials depending on use case) presenting the physical token, as indicated by operation 102. In some embodiments, this may include a user inserting their ATM card into a card reader at an ATM machine, inserting their credit card into a credit card reader on an ATM or vending machine, or the other examples described above. In response, the interactive kiosk may read an account identifier from the presented token, as indicated by block 104 and send the account identifier to an account management application, as indicated by block 106. Or in some embodiments, the account identifier may be sent directly to the authentication application. In some embodiments, the account management application may request authentication in response to receiving the account identifier, as indicated by block 108, for instance, with a request including the account identifier (which may include a transformation based on the received account identifier, like a cryptographic hash of the received account identifier or a translation into a different namespace). Reference to a single “account identifier” herein includes use cases in which the value specifying the account changes: e.g., a single account identifier may be specified both in plain text form, cyphertext form, cryptographic hash form, or in different namespaces, while still being a single account identifier.

In response to receiving the request, the authentication application may identify (e.g., select from among a plurality of candidates) a profile of the account, as indicated by block 110, such as a record associated with (e.g., uniquely identified by) the received account identifier. In some embodiments, the account identifier may distinguish the record from a plurality of other records corresponding to different user accounts in the above-describe repository and may form one or more bases by which that account is selected. Some embodiments may then identify a mobile device from the profile that is selected, as indicated by block 112. In some embodiments, this may include identifying a network accessible address of the mobile computing device described above. Some embodiments may then request biometric authentication from that mobile computing device by sending a request to that address, as indicated by block 114. Or in some embodiments, this may be accomplished by sending a request through an intermediate service, such as a push notification service hosted by a third-party (like a provider of the mobile device OS), an arrangement consistent with descriptions of sending a request to the mobile computing device. In some embodiments, the request may be a push communication, which is a communication that is not sent in response to a corresponding request for the data conveyed in the communication from the mobile computing device. Push communications are expected to conserve battery of mobile computing devices and relatively scarce wireless bandwidth by avoiding or reducing the need for the mobile computing device to periodically send pull request for communications to obtain those notifications in a timely fashion. Or some embodiments may implement period pull requests from the mobile computing device, which is not to suggest that any other feature is not also amenable to variation.

In some embodiments, the mobile computing device may receive the push communication, as indicated by block 116. In some embodiments, the above-describe client authentication application 48 may register with a service of the operating system 46 to receive notifications sent to that application, and a background process of the authentication application or the operating system may launch an event handler of the client authentication application to process the received push communication. In some embodiments, the push communication may include a transaction identifier of a current given transaction, for example, a value that uniquely distinguishes a given presentation of the token 102, like a count incremented with each presentation of a token is appended to a unique identifier of the interactive kiosk. The resulting value may be generated by the interactive kiosk and carried through the above-describe communications and the below-describe communications to associate different aspects of session state.

In some embodiments, the client authentication application 48 may present a notification on the mobile computing device inviting the user to configure and authenticate a transaction. Upon selecting that notification, the user interface of the client authentication application 48 may be launched, and the user may be presented with one or more inputs by which the user may initiate one or two-way video communication or audio communication with a user at the interactive kiosk 12. The interactive kiosk 12 may be identified with the transaction identifier and video or audio data may be exchanged via the authentication application 18, the account management application, or directly between the mobile computing device and the interactive kiosk, for example, via a WebRTC exchange to reduce an amount of bandwidth consumed by streaming video passing through the authentication application or the account management application. Some embodiments may include the interactive kiosk streaming video, as indicated by block 107, and the mobile computing device displaying the video stream, as indicated by block 117.

The user interface may further present an input by which a user may select a mode in which the user is invited to configure a scope of access in the designated transaction. In some embodiments, a user may input one or more values into this user interface to configure the access scope, as indicated by block 118, for instance in accordance with the examples described above. For example, a user may indicate that $20 is to be dispensed from the ATM machine from their checking account, rather than their savings account, or a user may indicate that a specified amount of fuel or no more than a specified dollar value or volume is to be dispensed by a gas station pump.

In some embodiments, the user interface may further include an input by which the user may initiate a biometric measurement and, upon the user selecting the input, some embodiments may sense a biometric attribute of the user, as indicated by block 120. Some embodiments may then verify the sensed attribute, as indicated by block 122, for example, by inputting one or more sensed biometric attributes into a configured classification model that is configured based upon previously supplied measurements from a user of the biometric attribute. Some embodiments may then send a result of the verification (indicating whether the sensed biometric attribute matches those previously supplied) and a device identifier of the mobile computing device to the authentication application, which may receive the result, as indicated by block 124.

Some embodiments may determine whether the device identifier still matches the device to which the push communication was sent. To impede man-in-the-middle attacks and malicious client-side code, some embodiments may determine whether the communication was received from a different application on the mobile computing device. For example, some embodiments may cryptographically sign, on the mobile computing device, the result of the verification operation with a private cryptographic key stored in a portion of memory of the mobile computing device to which only the client authentication application has access and to which other applications executing on the mobile computing device do not have access. In some embodiments, the authentication application may access a public key corresponding to the mobile computing device and verify with the public key that the cryptographic signature was made by a computing device with access to the private cryptographic key. Upon determining that there is no match, some embodiments may determine to not authenticate the user, or upon determining that there is a match, some embodiments may proceed to determine whether the result indicates the user should be authenticated, as indicated by block 126.

Upon determining that the biometric attribute is not verified by the computing device to which the communication was pushed, some embodiments may instruct the account management application to deny access, as indicated by block 128, which may send an instruction to the interactive kiosk to alert the user to the denied access, as indicated by block 130.

Alternatively, upon determining that the biometric attribute is verified by the computing device to which the communication was pushed, some embodiments may authorize access to the secure resource, as indicated by block 132 and send a communication from the account management application to the interactive kiosk to that effect. In response, the interactive kiosk may provide access within the scope specified in operation 118, as indicated by block 134. In some embodiments, this may include dispensing an amount of currency specified via the user interface of the mobile computing device, dispensing an amount of fuel specified in that user interface, dispensing an item in a vending machine specified on that user interface, or the like. Dispensing may include selecting among a plurality of actuators corresponding to different items, and instructing those actuators to engage in a designated number of actuated movements to dispense the appropriate amount of each selected item. For instance, stepper motors associated with different currency denominations may be caused to rotate a designated number of times to dispense the amount of currency selected. Or various doors may be unlocked in accordance with the other examples described above, e.g., by actuating a solenoid or electromagnet otherwise locking a door. Upon providing access, the presenting user may receive the secure resources, as indicated by block 136.

Thus, in some cases, a different user may receive the resources than the user providing the biometric verification, and the user providing the biometric verification may delegate access to their account, for example, by giving their physical token to a friend and then remotely authenticating a transaction for the friend by supplying a measurement of the appropriate biometric attribute.

FIG. 3 shows another example of a process that may be performed by the computing environment 10 described above, but which again is not limited to that implementation, which is not to suggest that any other description herein is limiting. Again, the operations described may be effectuated by executing instructions with one or more processors that are stored on a tangible, non-transitory, machine-readable medium, which as noted elsewhere herein, may include a distributed medium in which different subsets of instructions are stored in different computing devices and executed by different processors. Further, the caveats described above with reference to FIG. 2 by which the process may be varied in accordance with some embodiments apply here as well, and as well to the operations described with reference to FIG. 1.

The process of FIG. 3 may be similar to that of FIG. 2, except that in some embodiments, rather than a push notification, the communications from the mobile computing device may be tied to a transaction at interactive kiosk via a one-time code generated at the kiosk and conveyed directly wirelessly to the mobile computing device, for example, in virtue of physical proximity of the mobile computing device placing the mobile computing device within wireless range of the interactive kiosk. In some embodiments, the operations of the process 150 may be the same as those described above, in which case the same element numbers are used and the description above is incorporated.

In some embodiments, the process 150 includes a user presenting a physical token, as indicated by block 102, and the interactive kiosk reading an account identifier from the physical token, as indicated by block 104. Next, in response to a transaction being initiated, for example, by the user pressing a physical token, the interactive kiosk may generate a one-time code, as indicated by block 152. In some embodiments, the one-time code may be a relatively high entropy value that is difficult to guess and that expires after some duration of time, like less than 15 minutes. Some embodiments may generate a pseudorandom value for the generated code, in some cases appending a unique identifier of the interactive kiosk to that pseudorandom value to avoid namespace conflicts with generated codes from other interactive kiosks that happen to generate the same pseudorandom value during the same duration of time in which the random values are valid.

Some embodiments may then send the account identifier and the generated code, and in some cases, a transaction identifier, to the account management application, as indicated by block 154. Further, some embodiments may display or otherwise wirelessly convey the code, as indicated by block 156, to the mobile computing device which may sense the code, as indicated by block 160. In some cases, sensing the code may include receiving an NFC wireless transmission via an antenna of the mobile computing device, receiving a code encoded in Bluetooth™ transmission or Wi-Fi™ transmission, or optically sensing the code via a camera of the mobile computing device and extracting the code from a machine-readable image within the display of the user interface of the interactive kiosk (e.g., in operation 156) captured by the camera of the mobile computing device. In some embodiments account management application may request authentication w/ code and account id., as indicated by block 158.

Concurrently in some cases, the account management application may request the authentication application to identify a profile of an account associated with the account identifier, as indicated by block 110 and the authentication application may identify a mobile device (also referred to as a mobile computing device) from the profile of the account, as indicated by block 112. The authentication application may then determine whether the subsequently described communication is received within less than a threshold duration of time as a condition of authenticating the user, for instance, within less than 5-minutes, less than 20-minutes, or less than an hour.

Again, and in some cases concurrently, upon sensing the code, some embodiments of the mobile computing devices client authentication application may present the user interfaces described above by which a user may configure access scope, as indicated by block 116, and sense biometric attributes, as described by block 120 The mobile computing device may verify the sensed attribute, as indicated by block 124 and, then, send a result, a device identifier, and the code, as indicated by block 124. The authentication application may receive these values, as indicated by block 162 and determine whether the received code matches a code associated with any of a plurality of request for authentication received within a threshold duration of time. Some embodiments may select the corresponding request from among the plurality of pending requests in the course of determining whether the code matches one of these requests, as indicated by block 164. Some embodiments may periodically expire pending requests older than a threshold age, e.g., by deleting a record of the older pending request from a list of pending requests interrogated to identify matches. Upon determining that there is no match, some embodiments may proceed to deny access as indicated by block 128. Alternatively, some embodiments may proceed to determine whether the device identifier of the mobile computing device matches a device identifier identified in block 112, as indicated by block 156. Upon determining that there is no match, some embodiments may proceed to deny access, as indicated by block 128. Alternatively, upon determining that the device identifiers match, some embodiments may determine whether to authenticate the user based on the result of the biometric verification, as indicated by block 126. Upon determining that the user's sensed biometric attribute was not determined to match those previously supplied, some embodiments may proceed to block 128 and deny access. Alternatively, upon determining that the biometric attribute was determined to match, some embodiments may proceed to instruct the account management application to authorize access to the secure resource, as indicated by block 132. As described above, users may be alerted to denied access, as described by block 130, or users may be provided access within the configured scope, as indicated by block 134 via the interactive kiosk and receive the secured resources, as indicated by block 136.

FIG. 4 is a diagram that illustrates an exemplary computing system 1000 in accordance with embodiments of the present technique. Various portions of systems and methods described herein, may include or be executed on one or more computer systems similar to computing system 1000. Further, processes and modules described herein may be executed by one or more processing systems similar to that of computing system 1000.

Computing system 1000 may include one or more processors (e.g., processors 1010a-1010n) coupled to system memory 1020, an input/output I/O device interface 1030, and a network interface 1040 via an input/output (I/O) interface 1050. A processor may include a single processor or a plurality of processors (e.g., distributed processors). A processor may be any suitable processor capable of executing or otherwise performing instructions. A processor may include a central processing unit (CPU) that carries out program instructions to perform the arithmetical, logical, and input/output operations of computing system 1000. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 1020). Computing system 1000 may be a uni-processor system including one processor (e.g., processor 1010a), or a multi-processor system including any number of suitable processors (e.g., 1010a-1010n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus can also be implemented as, special purpose logic circuitry, e.g., an FPGA (field programmable gate array) or an ASIC (application specific integrated circuit). Computing system 1000 may include a plurality of computing devices (e.g., distributed computer systems) to implement various processing functions.

I/O device interface 1030 may provide an interface for connection of one or more I/O devices 1060 to computer system 1000. I/O devices may include devices that receive input (e.g., from a user) or output information (e.g., to a user). I/O devices 1060 may include, for example, graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 1060 may be connected to computer system 1000 through a wired or wireless connection. I/O devices 1060 may be connected to computer system 1000 from a remote location. I/O devices 1060 located on remote computer system, for example, may be connected to computer system 1000 via a network and network interface 1040.

Network interface 1040 may include a network adapter that provides for connection of computer system 1000 to a network. Network interface may 1040 may facilitate data exchange between computer system 1000 and other devices connected to the network. Network interface 1040 may support wired or wireless communication. The network may include an electronic communication network, such as the Internet, a local area network (LAN), a wide area network (WAN), a cellular communications network, or the like.

System memory 1020 may be configured to store program instructions 1100 or data 1110. Program instructions 1100 may be executable by a processor (e.g., one or more of processors 1010a-1010n) to implement one or more embodiments of the present techniques. Instructions 1100 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one or more computer processors located locally at one site or distributed across multiple remote sites and interconnected by a communication network.

System memory 1020 may include a tangible program carrier having program instructions stored thereon. A tangible program carrier may include a non-transitory computer readable storage medium. A non-transitory computer readable storage medium may include a machine readable storage device, a machine readable storage substrate, a memory device, or any combination thereof. Non-transitory computer readable storage medium may include non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM and/or DVD-ROM, hard-drives), or the like. System memory 1020 may include a non-transitory computer readable storage medium that may have program instructions stored thereon that are executable by a computer processor (e.g., one or more of processors 1010a-1010n) to cause the subject matter and the functional operations described herein. A memory (e.g., system memory 1020) may include a single memory device and/or a plurality of memory devices (e.g., distributed memory devices). Instructions or other program code to provide the functionality described herein may be stored on a tangible, non-transitory computer readable media. In some cases, the entire set of instructions may be stored concurrently on the media, or in some cases, different parts of the instructions may be stored on the same media at different times.

I/O interface 1050 may be configured to coordinate I/O traffic between processors 1010a-1010n, system memory 1020, network interface 1040, I/O devices 1060, and/or other peripheral devices. I/O interface 1050 may perform protocol, timing, or other data transformations to convert data signals from one component (e.g., system memory 1020) into a format suitable for use by another component (e.g., processors 1010a-1010n). I/O interface 1050 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computer system 1000 or multiple computer systems 1000 configured to host different portions or instances of embodiments. Multiple computer systems 1000 may provide for parallel or sequential processing/execution of one or more portions of the techniques described herein.

Those skilled in the art will appreciate that computer system 1000 is merely illustrative and is not intended to limit the scope of the techniques described herein. Computer system 1000 may include any combination of devices or software that may perform or otherwise provide for the performance of the techniques described herein. For example, computer system 1000 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, or a Global Positioning System (GPS), or the like. Computer system 1000 may also be connected to other devices that are not illustrated, or may operate as a stand-alone system. In addition, the functionality provided by the illustrated components may in some embodiments be combined in fewer components or distributed in additional components. Similarly, in some embodiments, the functionality of some of the illustrated components may not be provided or other additional functionality may be available.

Those skilled in the art will also appreciate that while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1000 may be transmitted to computer system 1000 via transmission media or signals such as electrical, electromagnetic, or digital signals, conveyed via a communication medium such as a network or a wireless link. Various embodiments may further include receiving, sending, or storing instructions or data implemented in accordance with the foregoing description upon a computer-accessible medium. Accordingly, the present techniques may be practiced with other computer system configurations.

In block diagrams, illustrated components are depicted as discrete functional blocks, but embodiments are not limited to systems in which the functionality described herein is organized as illustrated. The functionality provided by each of the components may be provided by software or hardware modules that are differently organized than is presently depicted, for example such software or hardware may be intermingled, conjoined, replicated, broken up, distributed (e.g. within a data center or geographically), or otherwise differently organized. The functionality described herein may be provided by one or more processors of one or more computers executing code stored on a tangible, non-transitory, machine readable medium. In some cases, notwithstanding use of the singular term “medium,” the instructions may be distributed on different storage devices associated with different computing devices, for instance, with each computing device having a different subset of the instructions, an implementation consistent with usage of the singular term “medium” herein. In some cases, third party content delivery networks may host some or all of the information conveyed over networks, in which case, to the extent information (e.g., content) is said to be supplied or otherwise provided, the information may provided by sending instructions to retrieve that information from a content delivery network.

The reader should appreciate that the present application describes several independently useful techniques. Rather than separating those techniques into multiple isolated patent applications, applicants have grouped these techniques into a single document because their related subject matter lends itself to economies in the application process. But the distinct advantages and aspects of such techniques should not be conflated. In some cases, embodiments address all of the deficiencies noted herein, but it should be understood that the techniques are independently useful, and some embodiments address only a subset of such problems or offer other, unmentioned benefits that will be apparent to those of skill in the art reviewing the present disclosure. Due to costs constraints, some techniques disclosed herein may not be presently claimed and may be claimed in later filings, such as continuation applications or by amending the present claims. Similarly, due to space constraints, neither the Abstract nor the Summary of the Invention sections of the present document should be taken as containing a comprehensive listing of all such techniques or all aspects of such techniques.

It should be understood that the description and the drawings are not intended to limit the present techniques to the particular form disclosed, but to the contrary, the intention is to cover all modifications, equivalents, and alternatives falling within the spirit and scope of the present techniques as defined by the appended claims. Further modifications and alternative embodiments of various aspects of the techniques will be apparent to those skilled in the art in view of this description. Accordingly, this description and the drawings are to be construed as illustrative only and are for the purpose of teaching those skilled in the art the general manner of carrying out the present techniques. It is to be understood that the forms of the present techniques shown and described herein are to be taken as examples of embodiments. Elements and materials may be substituted for those illustrated and described herein, parts and processes may be reversed or omitted, and certain features of the present techniques may be utilized independently, all as would be apparent to one skilled in the art after having the benefit of this description of the present techniques. Changes may be made in the elements described herein without departing from the spirit and scope of the present techniques as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” and the like mean including, but not limited to. As used throughout this application, the singular forms “a,” “an,” and “the” include plural referents unless the content explicitly indicates otherwise. Thus, for example, reference to “an element” or “a element” includes a combination of two or more elements, notwithstanding use of other terms and phrases for one or more elements, such as “one or more.” The term “or” is, unless indicated otherwise, non-exclusive, i.e., encompassing both “and” and “or.” Terms describing conditional relationships, e.g., “in response to X, Y,” “upon X, Y,”, “if X, Y,” “when X, Y,” and the like, encompass causal relationships in which the antecedent is a necessary causal condition, the antecedent is a sufficient causal condition, or the antecedent is a contributory causal condition of the consequent, e.g., “state X occurs upon condition Y obtaining” is generic to “X occurs solely upon Y” and “X occurs upon Y and Z.” Such conditional relationships are not limited to consequences that instantly follow the antecedent obtaining, as some consequences may be delayed, and in conditional statements, antecedents are connected to their consequents, e.g., the antecedent is relevant to the likelihood of the consequent occurring. Statements in which a plurality of attributes or functions are mapped to a plurality of objects (e.g., one or more processors performing steps A, B, C, and D) encompasses both all such attributes or functions being mapped to all such objects and subsets of the attributes or functions being mapped to subsets of the attributes or functions (e.g., both all processors each performing steps A-D, and a case in which processor 1 performs step A, processor 2 performs step B and part of step C, and processor 3 performs part of step C and step D), unless otherwise indicated. Further, unless otherwise indicated, statements that one value or action is “based on” another condition or value encompass both instances in which the condition or value is the sole factor and instances in which the condition or value is one factor among a plurality of factors. Unless otherwise indicated, statements that “each” instance of some collection have some property should not be read to exclude cases where some otherwise identical or similar members of a larger collection do not have the property, i.e., each does not necessarily mean each and every. Limitations as to sequence of recited steps should not be read into the claims unless explicitly specified, e.g., with explicit language like “after performing X, performing Y,” in contrast to statements that might be improperly argued to imply sequence limitations, like “performing X on items, performing Y on the X'ed items,” used for purposes of making claims more readable rather than specifying sequence. Statements referring to “at least Z of A, B, and C,” and the like (e.g., “at least Z of A, B, or C”), refer to at least Z of the listed categories (A, B, and C) and do not require at least Z units in each category. Unless specifically stated otherwise, as apparent from the discussion, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device.

In this patent, to the extent certain U.S. patents, U.S. patent applications, or other materials (e.g., articles) have been incorporated by reference. The text of such U.S. patents, U.S. patent applications, and other materials is, however, only incorporated by reference to the extent that no conflict exists between such material and the statements and drawings set forth herein. In the event of such conflict, the text of the present document governs.

The present techniques will be better understood with reference to the following enumerated embodiments:

1. A tangible, non-transitory, machine-readable medium storing instructions that when executed by one or more processors effectuate operations comprising: obtaining, from an interactive kiosk, with one or more processors executing at least part of a remote authentication application, an account identifier, wherein: the remote authentication application is physically remote from the interactive kiosk, the account identifier distinguishes a given account from a plurality of accounts accessible via the interactive kiosk, the account identifier is communicated to the interactive kiosk from a physical token, the physical token is presented by a presenting user to the interactive kiosk, the presenting user is physically present at the interactive kiosk, and the account identifier is obtained based on data read from memory of the physical token upon presentation of the physical token to the interactive kiosk; accessing, with one or more processors executing at least part of the authentication application, a record that associates the account identifier with an identifier of a mobile computing device; receiving, with one or more processors executing at least part of the authentication application, from the mobile computing device associated with the account identifier obtained from the physical token by the interactive kiosk, via the network, a value indicative of whether a sensed biometric attribute matches a previously obtained biometric attribute of a biometric-verification user, wherein the value is obtained at least in part by sensing, with the mobile computing device, the biometric attribute of the biometric-verification user; determining, with one or more processors executing at least part of the remote authentication application, based on the value indicative of whether the sensed biometric attribute matches the previously obtained biometric attribute of the biometric-verification user, to authenticate the presenting user; and upon determining to authenticate the user, causing, with one or more processors executing at least part of the remote authentication application, the interactive kiosk to provide the presenting user access to a secured resource.
2. The medium of embodiment 1, wherein: the presenting user and the biometric-verification user are the same given user; the interactive kiosk is an automated teller machine (ATM); the physical token is an ATM card; the operations comprise: reading the account identifier from the ATM card by the ATM, sensing, with the mobile computing device associated with the account identifier obtained from the physical token by the interactive kiosk, the biometric attribute of the biometric-verification user, and determining, with the mobile computing device, that the sensed biometric attribute matches the previously obtained biometric attribute of the biometric-verification user based on a record of the previously obtained biometric attribute of the biometric-verification user in memory of the mobile computing device; and the given user is granted access to money from the ATM without the given user entering a personal identification number in the ATM based on the given user demonstrating, with the biometric attribute, possession of the mobile computing device associated with the account identifier.
3. The medium of any one of embodiments 1-2, wherein: the presenting user and the biometric-verification user are not the same user; the biometric-verification user has delegated access to the presenting user; the biometric-verification user and the mobile computing device are not physically present at the interactive kiosk; the operations comprise receiving, with one or more processors executing at least part of the authentication application, from the mobile computing device, data specifying a scope of access to the secured resources, the scope being a subset of secured resources in an account associated with the account identifier; and causing the interactive kiosk to provide the presenting user access to the secured resource comprises: causing the interactive kiosk to provide the presenting user access to secured resources within the scope of access specified by data received from the mobile computing device; and causing the interactive kiosk to prevent the presenting user from accessing secured resources outside the scope of access specified by data received from the mobile computing device.
4. The medium of embodiment 3, wherein the operations comprise: sensing, with a camera of the interactive kiosk, an image of the presenting user; causing, with the interactive kiosk, the image to be sent to the mobile computing device; and displaying, with the mobile computing device, the image of the presenting user to the biometric-verification user before the biometric-verification user is sensed by the mobile computing device to provide the biometric attribute.
5. The medium of embodiment 4, wherein the operations comprise: causing a video feed from the camera to be streamed to the mobile computing device, the video feed including the image.
6. The medium of any one of embodiments 1-5, wherein the operations comprise: transmitting, wirelessly from the interactive kiosk, a code value, wherein: the code value has greater than 12 bits of entropy, and the code value changes between user sessions with the interactive kiosk for a given user; receiving, with the mobile user device, the code value from the wireless transmission; sending, from the mobile user device, via the network, to the remote authentication application, a value demonstrating possession of the code value by the mobile computing device; determining, based on receiving from the mobile computing device the value demonstrating possession of the code value by the mobile computing device, that the mobile computing device is possessed by the presenting user, wherein determining to authenticate the presenting user comprises determining to authenticate the presenting user based on the determination that the mobile computing device is possessed by the presenting user.
7. The medium of embodiment 6, wherein: transmitting the code value comprises displaying a machine-readable image encoding the code value on a display of the interactive kiosk; and receiving the code value comprises sensing the machine-readable image with a camera of the mobile computing device.
8. The medium of embodiment 6, wherein: transmitting the code value comprises transmitting, with a radio of the interactive kiosk, a near-field communication (NFC) transmission encoding the code value; and receiving the code value comprises receiving the NFC transmission with an antenna of the mobile computing device.
9. The medium of any one of embodiments 1-8, wherein operations comprise: sending, from the remote authentication application, via the network, to a client-side authentication application executing as a native application on the mobile computing device, as a push communication, without being prompted by a request from the mobile computing device, a request for biometric authentication of the biometric-verification user.
10. The medium of embodiment 9, wherein the operations comprise: receiving the push communication with the mobile computing device and, in response to receiving the push communication, presenting, with the client-side authentication application, a user interface on the mobile computing device by which the user is invited to measure the biometric attribute with a sensor of the mobile computing device; sending an instruction from the remote authentication application to the client-side authentication application instructing the client-side authentication application to send a value indicative of access to a cryptographic key stored in memory of the mobile computing device, wherein cryptographic key is stored in a location or format accessible to the client-side authentication application but not to other untrusted applications executing on the mobile computing device; receiving, via the network, from the client-side authentication application, with the remote authentication application, the value indicative of access to the cryptographic key; and determining, with the remote authentication application, based on the received value and a reference value stored in memory that the value indicative of whether the sensed biometric attribute matches the previously obtained biometric attribute was sent by the client-side authentication application and not another untrusted application executing on the mobile computing device.
11. The medium of any one of embodiments 1-10, wherein: the mobile computing device determines whether the sensed biometric attribute matches the previously obtained biometric attribute of the biometric-verification user; the operations comprise: forming the value indicative of whether the sensed biometric attribute matches the previously obtained biometric attribute of the biometric-verification user by cryptographically signing result of the determination with the mobile computing device, wherein the result of the determination is cryptographically signed with a private cryptographic key of the mobile computing device; verifying, by the remote authentication application, the cryptographically signed result of the determination with a public key associated with the mobile computing device.
12. The medium of any one of embodiments 1-11, wherein: the biometric attribute is based on an iris measurement, a retina measurement, a fingerprint measurement, a facial measurement, a thermal measurement, or a depth-sensor measurement of a part of the biometric-verification user's body.
13. The medium of any one of embodiments 1-12, wherein: the interactive kiosk is an ATM.
14. The medium of any one of embodiments 1-13, wherein: the interactive kiosk is a vending machine.
15. The medium of any one of embodiments 1-14, wherein the operations comprise: presenting an interface on the mobile computing device by which the biometric-verification user selects an item or amount of items to be dispensed by an ATM or other vending machine; receiving a selection via the user interface on the mobile computing device, the selection indicating a given item or amount of items to be dispensed; and causing the given item or amount of items to be dispensed by the ATM or other vending machine without the presenting user specifying the selection through physical contact with the interactive kiosk.
16. A method, comprising: the operations of any one of embodiments 1-15.
17. A system, comprising: one or more processors; and memory storing instructions that when executed by the processors cause the processors to effectuate operations comprising: the operations of any one of embodiments 1-15.

What is claimed is:

1. A tangible, non-transitory, machine-readable medium storing instructions that when executed by one or more processors effectuate operations comprising:
obtaining, from an interactive kiosk, with one or more processors executing at least part of a remote authentication application, an account identifier, wherein:
the remote authentication application is physically remote from the interactive kiosk,
the account identifier distinguishes a given account from a plurality of accounts accessible via the interactive kiosk,
the account identifier is communicated to the interactive kiosk from a physical token,
the physical token is presented by a presenting user to the interactive kiosk,
the presenting user is physically present at the interactive kiosk, and
the account identifier is obtained based on data read from memory of the physical token upon presentation of the physical token to the interactive kiosk;
accessing, with one or more processors executing at least part of the authentication application, a record that associates the account identifier with an identifier of a mobile computing device;
receiving, with one or more processors executing at least part of the authentication application, from the mobile computing device associated with the account identifier obtained from the physical token by the interactive kiosk, via the network, a value indicative of whether a sensed biometric attribute matches a previously obtained biometric attribute of a biometric-verification user, wherein the value is obtained at least in part by sensing, with the mobile computing device, the biometric attribute of the biometric-verification user;
determining, with one or more processors executing at least part of the remote authentication application, based on the value indicative of whether the sensed biometric attribute matches the previously obtained biometric attribute of the biometric-verification user, to authenticate the presenting user; and
upon determining to authenticate the user, causing, with one or more processors executing at least part of the remote authentication application, the interactive kiosk to provide the presenting user access to a secured resource.

2. The medium of claim 1, wherein:
the presenting user and the biometric-verification user are the same given user;
the interactive kiosk is an automated teller machine (ATM);
the physical token is an ATM card;
the operations comprise:
reading the account identifier from the ATM card by the ATM,
sensing, with the mobile computing device associated with the account identifier obtained from the physical token by the interactive kiosk, the biometric attribute of the biometric-verification user, and
determining, with the mobile computing device, that the sensed biometric attribute matches the previously obtained biometric attribute of the biometric-verification user based on a record of the previously obtained biometric attribute of the biometric-verification user in memory of the mobile computing device; and
the given user is granted access to money from the ATM without the given user entering a personal identification number in the ATM based on the given user demonstrating, with the biometric attribute, possession of the mobile computing device associated with the account identifier.

3. The medium of claim 1, wherein:
the presenting user and the biometric-verification user are not the same user;
the biometric-verification user has delegated access to the presenting user;
the biometric-verification user and the mobile computing device are not physically present at the interactive kiosk;
the operations comprise receiving, with one or more processors executing at least part of the authentication application, from the mobile computing device, data specifying a scope of access to the secured resources, the scope being a subset of secured resources in an account associated with the account identifier; and
causing the interactive kiosk to provide the presenting user access to the secured resource comprises:
causing the interactive kiosk to provide the presenting user access to secured resources within the scope of access specified by data received from the mobile computing device; and
causing the interactive kiosk to prevent the presenting user from accessing secured resources outside the scope of access specified by data received from the mobile computing device.

4. The medium of claim 3, wherein the operations comprise:
sensing, with a camera of the interactive kiosk, an image of the presenting user;
causing, with the interactive kiosk, the image to be sent to the mobile computing device; and
displaying, with the mobile computing device, the image of the presenting user to the biometric-verification user before the biometric-verification user is sensed by the mobile computing device to provide the biometric attribute.

5. The medium of claim 4, wherein the operations comprise:
causing a video feed from the camera to be streamed to the mobile computing device, the video feed including the image.

6. The medium of claim 1, wherein the operations comprise:
transmitting, wirelessly from the interactive kiosk, a code value, wherein:
the code value has greater than 12 bits of entropy, and
the code value changes between user sessions with the interactive kiosk for a given user;
receiving, with the mobile user device, the code value from the wireless transmission;
sending, from the mobile user device, via the network, to the remote authentication application, a value demonstrating possession of the code value by the mobile computing device;
determining, based on receiving from the mobile computing device the value demonstrating possession of the code value by the mobile computing device, that the mobile computing device is possessed by the presenting user, wherein determining to authenticate the presenting user comprises determining to authenticate the presenting user based on the determination that the mobile computing device is possessed by the presenting user.

7. The medium of claim 6, wherein:
transmitting the code value comprises displaying a machine-readable image encoding the code value on a display of the interactive kiosk; and
receiving the code value comprises sensing the machine-readable image with a camera of the mobile computing device.

8. The medium of claim 6, wherein:
transmitting the code value comprises transmitting, with a radio of the interactive kiosk, a near-field communication (NFC) transmission encoding the code value; and
receiving the code value comprises receiving the NFC transmission with an antenna of the mobile computing device.

9. The medium of claim 1, wherein operations comprise:
sending, from the remote authentication application, via the network, to a client-side authentication application executing as a native application on the mobile computing device, as a push communication, without being prompted by a request from the mobile computing device, a request for biometric authentication of the biometric-verification user.

10. The medium of claim 9, wherein the operations comprise:
receiving the push communication with the mobile computing device and, in response to receiving the push communication, presenting, with the client-side authentication application, a user interface on the mobile computing device by which the user is invited to measure the biometric attribute with a sensor of the mobile computing device;
sending an instruction from the remote authentication application to the client-side authentication application instructing the client-side authentication application to send a value indicative of access to a cryptographic key stored in memory of the mobile computing device,
wherein cryptographic key is stored in a location or format accessible to the client-side authentication application but not to other untrusted applications executing on the mobile computing device;
receiving, via the network, from the client-side authentication application, with the remote authentication application, the value indicative of access to the cryptographic key; and
determining, with the remote authentication application, based on the received value and a reference value stored in memory that the value indicative of whether the sensed biometric attribute matches the previously obtained biometric attribute was sent by the client-side authentication application and not another untrusted application executing on the mobile computing device.

11. The medium of claim 1, wherein:
the mobile computing device determines whether the sensed biometric attribute matches the previously obtained biometric attribute of the biometric-verification user;
the operations comprise:
forming the value indicative of whether the sensed biometric attribute matches the previously obtained biometric attribute of the biometric-verification user by cryptographically signing result of the determination with the mobile computing device, wherein the result of the determination is cryptographically signed with a private cryptographic key of the mobile computing device;
verifying, by the remote authentication application, the cryptographically signed result of the determination with a public key associated with the mobile computing device.

12. The medium of claim 1, wherein:
the biometric attribute is based on an iris measurement, a retina measurement, a fingerprint measurement, a facial measurement, a thermal measurement, or a depth-sensor measurement of a part of the biometric-verification user's body.

13. The medium of claim 1, wherein:
the interactive kiosk is an ATM.

14. The medium of claim 1, wherein:
the interactive kiosk is a vending machine.

15. The medium of claim 1, wherein the operations comprise:
presenting an interface on the mobile computing device by which the biometric-verification user selects an item or amount of items to be dispensed by an ATM or other vending machine;
receiving a selection via the user interface on the mobile computing device, the selection indicating a given item or amount of items to be dispensed; and
causing the given item or amount of items to be dispensed by the ATM or other vending machine without the presenting user specifying the selection through physical contact with the interactive kiosk.

16. The medium of claim 1, wherein:
obtaining the account identifier comprises steps for obtaining an account identifier from a physical token;
sensing the biometric attribute comprises steps for sensing a biometric attribute; and
the operations comprise steps for verifying a biometric attribute.

17. A method, comprising:
obtaining, from an interactive kiosk, with one or more processors executing at least part of a remote authentication application, an account identifier, wherein:
the remote authentication application is physically remote from the interactive kiosk,
the account identifier distinguishes a given account from a plurality of accounts accessible via the interactive kiosk,
the account identifier is communicated to the interactive kiosk from a physical token,
the physical token is presented by a presenting user to the interactive kiosk,
the presenting user is physically present at the interactive kiosk, and
the account identifier is obtained based on data read from memory of the physical token upon presentation of the physical token to the interactive kiosk;
accessing, with one or more processors executing at least part of the authentication application, a record that associates the account identifier with an identifier of a mobile computing device;
receiving, with one or more processors executing at least part of the authentication application, from the mobile computing device associated with the account identifier obtained from the physical token by the interactive kiosk, via the network, a value indicative of whether a sensed biometric attribute matches a previously obtained biometric attribute of a biometric-verification user, wherein the value is obtained at least in part by sensing, with the mobile computing device, the biometric attribute of the biometric-verification user;
determining, with one or more processors executing at least part of the remote authentication application, based on the value indicative of whether the sensed biometric attribute matches the previously obtained biometric attribute of the biometric-verification user, to authenticate the presenting user; and
upon determining to authenticate the user, causing, with one or more processors executing at least part of the remote authentication application, the interactive kiosk to provide the presenting user access to a secured resource.

18. The method of claim 17, wherein:
the presenting user and the biometric-verification user are the same given user;
the interactive kiosk is an automated teller machine (ATM);
the physical token is an ATM card;
the method comprises:
reading the account identifier from the ATM card by the ATM,
sensing, with the mobile computing device associated with the account identifier obtained from the physical token by the interactive kiosk, the biometric attribute of the biometric-verification user, and
determining, with the mobile computing device, that the sensed biometric attribute matches the previously obtained biometric attribute of the biometric-verification user based on a record of the previously obtained biometric attribute of the biometric-verification user in memory of the mobile computing device; and
the given user is granted access to money from the ATM without the given user entering a personal identification number in the ATM based on the given user demonstrating, with the biometric attribute, possession of the mobile computing device associated with the account identifier.

19. The method of claim 17, wherein:
the presenting user and the biometric-verification user are not the same user;
the biometric-verification user has delegated access to the presenting user;
the biometric-verification user and the mobile computing device are not physically present at the interactive kiosk;
the method comprises receiving, with one or more processors executing at least part of the authentication application, from the mobile computing device, data specifying a scope of access to the secured resources, the scope being a subset of secured resources in an account associated with the account identifier; and
causing the interactive kiosk to provide the presenting user access to the secured resource comprises:
causing the interactive kiosk to provide the presenting user access to secured resources within the scope of access specified by data received from the mobile computing device; and
causing the interactive kiosk to prevent the presenting user from accessing secured resources outside the scope of access specified by data received from the mobile computing device.

20. The method of claim 17, comprising:
transmitting, wirelessly from the interactive kiosk, a code value, wherein:
the code value has greater than 12 bits of entropy, and
the code value changes between user sessions with the interactive kiosk for a given user;
receiving, with the mobile user device, the code value from the wireless transmission;
sending, from the mobile user device, via the network, to the remote authentication application, a value demonstrating possession of the code value by the mobile computing device;
determining, based on receiving from the mobile computing device the value demonstrating possession of the code value by the mobile computing device, that the mobile computing device is possessed by the presenting user, wherein determining to authenticate the presenting user comprises determining to authenticate the presenting user based on the determination that the mobile computing device is possessed by the presenting user.
